(19) United States
(12) Patent Application Publication
(10) Pub. No.: US 2019/0286524 A1
(43) Pub. Date: Sep. 19, 2019

(54) INFORMATION PROCESSING SYSTEM, CONTROL METHOD OF INFORMATION PROCESSING SYSTEM, AND COMPUTER-REDABLE RECORDING MEDIUM

(71) Applicant: Fumiyuki YOSHIDA, Kanagawa (JP)

(72) Inventor: Fumiyuki YOSHIDA, Kanagawa (JP)

(73) Assignee: Ricoh Company, Ltd., Tokyo (JP)

(21) Appl. No.: 16/295,434

(22) Filed: Mar. 7, 2019

(30) Foreign Application Priority Data
Mar. 16, 2018 (JP) 2018-050251

(51) Int. Cl. G06F 11/14

(52) U.S. Cl. CPC G06F 11/1407; G06F 11/1438; G06F 11/1417; G06F 11/141

(57) ABSTRACT

According to an embodiment, an information processing system includes an information processing apparatus that has a status saving code expanded in a specific area being different from an area of an execution format file of an operating system in a memory space of the operating system, when booting or after booting of the operating system. The information processing apparatus determines a page table of the memory space by proceeding to the specific area to execute the status saving code in case of failure of the operating system, and stores contents of a virtual memory having a corresponding physical memory into a secondary storage device from a virtual memory space of the operating system.

### CROSS-REFERENCE TO RELATED APPLICATIONS

The present application claims priority under 35 U.S.C. § 119 to Japanese Patent Application No. 2018-050251, filed on Mar. 16, 2018. The contents of which are incorporated herein by reference in their entirety.

### BACKGROUND OF THE INVENTION

### 1. Field of the Invention

An embodiment relates to an information processing system, a control method of an information processing system, and a computer-readable recording medium.

### 2. Description of the Related Art

A function of saving a status at an abnormal termination when an abnormal termination occurs is not included, as a standard function, in general-purpose operating systems (OS), such as Linux (registered trademark), Unix (registered trademark)-like, and Tron, or real-time OSs. To analyze a cause of occurrence of an abnormality, an information processing system having a function of saving a status at abnormal termination has been needed.

Japanese Unexamined Patent Application Publication No. 2017-045320 discloses an information processing system that has a function of saving a page for which printing has not been completed and a snapshot of a guest OS when occurrence of a failure related to a printing device or control of the printing device is detected in a state in which a system is operating on a guest side. In this information processing system, virtualization support function of a central processing unit (CPU) is used.

However, the information processing system disclosed in Japanese Unexamined Patent Application Publication No. 2017-045320 cannot be implemented with a low cost personal computer (PC) not supporting virtualization, uses a large amount of memory, and is, therefore, not highly versatile. Furthermore, depending on a failure, there can be a situation in which the processing of collecting and saving information at a time of occurrence of an abnormality does not function normally due to the failure.

In view of the above problem, there is a need to provide an information processing system that is highly versatile and that is capable of saving a status at a time of occurrence of an abnormality without being affected by a failure.

### SUMMARY OF THE INVENTION

According to an embodiment, an information processing system includes an information processing apparatus that has a status saving code expanded in a specific area being different from an area of an execution format file of an operating system in a memory space of the operating system, when booting or after booting of the operating system. The information processing apparatus determines a page table of the memory space by proceeding to the specific area to execute the status saving code in case of failure of the operating system, and stores contents of a virtual memory having a corresponding physical memory into a secondary storage device from a virtual memory space of the operating system.

### BRIEF DESCRIPTION OF THE DRAWINGS

FIG. 1 is a schematic diagram illustrating a configuration of an information processing system according to an embodiment;

FIG. 2 is a diagram illustrating a memory space of an OS;

FIG. 3 is a diagram illustrating a structure of a status saving code;

FIG. 4 is a flowchart illustrating an action of the information processing system illustrated in FIG. 1 at a time of occurrence of a failure;

FIG. 5 is a flowchart illustrating a subroutine expressing page-table search processing;

FIG. 6 is a diagram illustrating a correspondence between a virtual memory space and a physical memory of an OS; and

FIG. 7 is a diagram illustrating a state in which a log of an OS is output to a secondary storage device.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Hereinafter, an embodiment of an information processing system, a control method of an information processing system, and a computer-readable recording medium having a control program of an information processing system is described with reference to the drawings. The embodiment is not intended to limit the present invention. Moreover, like reference symbols are given to identical or corresponding components throughout the drawings.

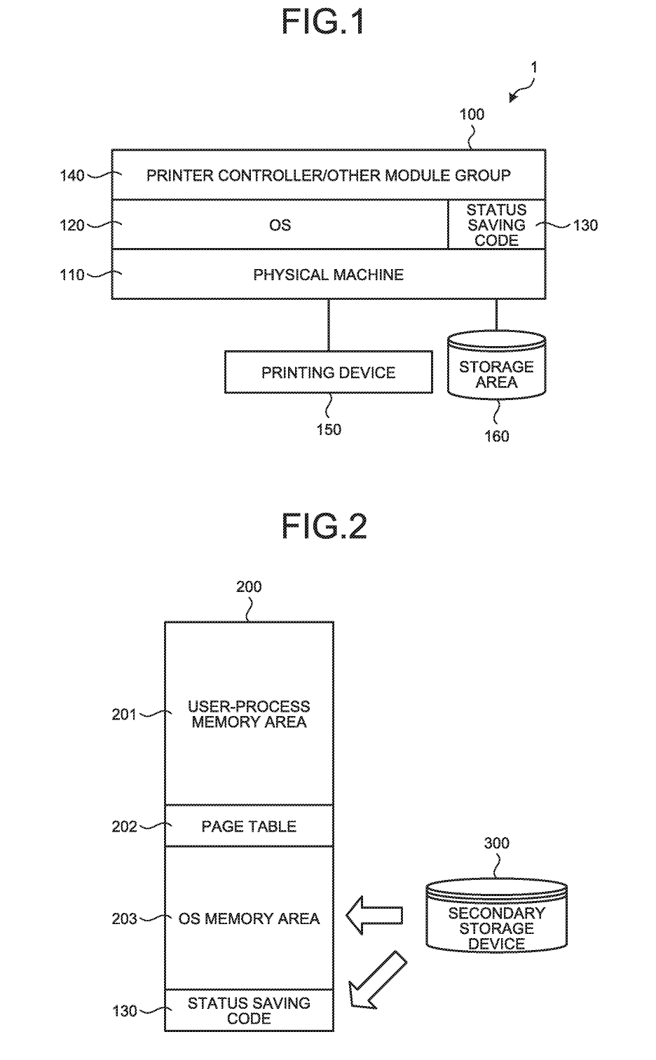

FIG. 1 is a schematic diagram illustrating a configuration of an information processing system according to an embodiment. As illustrated in FIG. 1, an information processing system 1 according to the present embodiment includes an information processing apparatus 100 including a physical machine 110, an OS 120, a status saving code 130, and a module group 140, a printing device 150, and a storage area 160.

The information processing apparatus 100 is a general computer that is constituted of a control device, such as a CPU, and a storage device, such as a read-only memory (ROM) and a random access memory (RAM), and has a function as a printer server or a printer controller that controls the printing device 150 that is, for example, a printer.

FIG. 2 is a diagram illustrating a memory space of the OS. As illustrated in FIG. 2, in a memory space 200 that is a memory space of the OS 120 of the information processing apparatus 100, a user-process memory area 201, a page table 202, an OS memory area 203, and the status saving code 130 are stored.

The page table 202 is “settings relating to memory area” that is used for virtual address-physical address conversion, or for solution of an attribute of a memory area. The page table 202 is stored in a specific position on the RAM of the information processing apparatus 100, and the CPU can refer to a corresponding page table by setting a relevant address to a register of the CPU. That is, it is possible to grasp which area is used in which way in the memory space 200 by interpreting this page table 202.

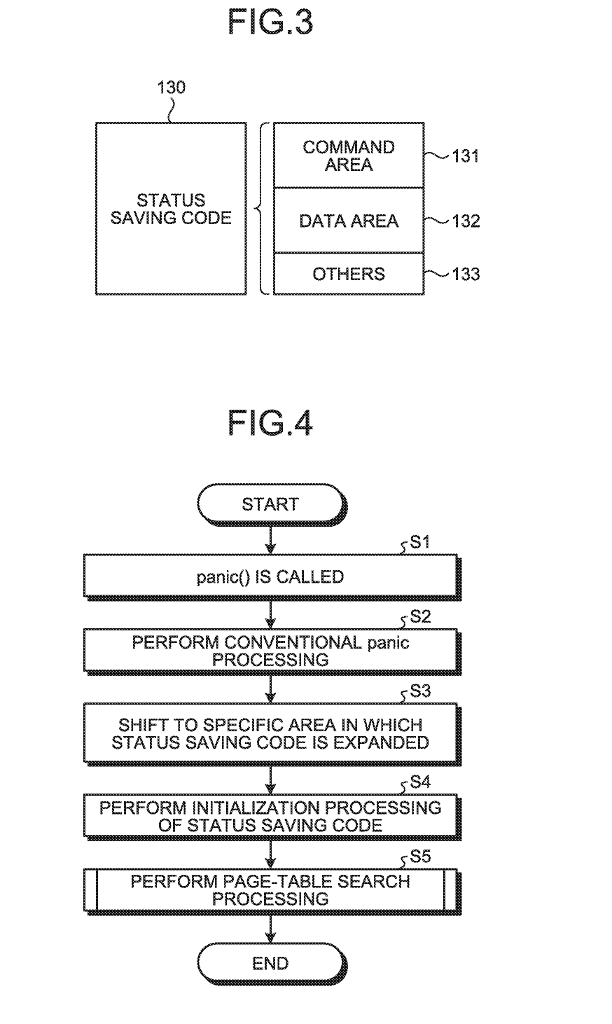

FIG. 3 is a diagram illustrating a structure of a status saving code. As illustrated in FIG. 3, the status saving code 130 includes a command area 131, a data area 132, and others 133. The status saving code 130 is expanded (expansion step) from a secondary storage device 300 in a specific area different from that of an execution format file of the OS 120 in the memory space 200 at a time of boot of the OS 120 or after the boot. In other words, the status saving code 130 is disabled to execute a subroutine of the OS 120 or to refer to data of the OS 120. This is for preventing the status saving code 130 from being affected by a failure of the OS 120.

When the status saving code 130 is expanded in a dynamically acquired memory area in the memory space 200, the command area 131 and the data area 132 are expanded in a specific area of the memory space 200 by a position-independent code (PIC). As a result, the status saving code 130 can be executed as it is wherever the status saving code 130 is stored in the memory space 200.

Furthermore, when the status saving code 130 is expanded in a predetermined area of the memory space 200, the command area 131 and the data area 132 are expanded in a specific area of the memory space 200 by linker script. The linker script is software to link programs, and is regarded as a file in which instructions with respect to linkers are described.

The information processing apparatus 100 shifts to a specific area and executes the status saving code 130 when a failure of the OS 120 occurs, and thereby searches for a page table of the memory space 200 and stores contents of a virtual memory having a corresponding physical memory into a secondary storage device from a virtual memory space 400 of the OS 120. The secondary storage device may be the secondary storage device 300, or may also be a storage device other than the secondary storage device 300.

Next, an operation of the information processing system 1 in case of failure is described. FIG. 4 is a flowchart illustrating an operation of the information processing system illustrated in FIG. 1 in case of failure. As illustrated in FIG. 4, in case of failure in the OS 120, a function referred to as panic( ) is called out with three patterns described in the following (step S1).

As a first pattern, there is a case in which the CPU of the information processing apparatus 100 detects an abnormality. Specifically, when an abnormal condition determined in a specification of the CPU of the information processing apparatus 100 is detected, an exemption is issued, and a command at a specific address is executed. When recovery of the abnormal condition is possible, recovery is attempted. On the other hand, when recovery is impossible, or when recovery fails, panic( ) is called out.

As a second pattern, there is a case in which a device other than the CPU of the information processing system 1 detects an abnormality. Specifically, when a device other than the CPU of the information processing system 1 detects some kinds of abnormality at a time of operation of the device, an abnormality interrupt occurs generally, and panic( ) is called out.

As a third pattern, there is a case in which the OS 120 detects an abnormality. Specifically, when a state that is correct as a command of the CPU of the information processing apparatus 100, but is not logically intended is detected, panic( ) is called out. For example, it is when a variable that is not supposed to be zero in a certain condition is zero.

In a case other than the three patterns described above also, generally, panic( ) is often called out when an abnormality is detected. Note that the status saving code 130 may be executed according to a processing other than the processing of calling out the panic( ).

When panic( ) is called out, firstly, conventional panic processing is performed (step S2).

Thereafter, the process proceeds to a specific area in which the status saving code 130 is expanded (step S3: shift step). Specifically, the process proceeds to an address indicating a head of the command area 131 in which the status saving code 130 is expanded at a tail of panic( ). Shifting the process can be implemented by a function pointer when C language is used. Moreover, direct description of a command of Assembla may be performed.

Subsequently, the status saving code 130 is executed. When the status saving code 130 is executed, firstly, status-saving-code initialization processing is performed (step S4). Specifically, data (variable) in the status saving code 130 is initialized to initial values. At this time, a “virtual address” is set to an initial value. Furthermore, a device that controls the secondary storage device is initialized.

Page-table search processing is then performed (step S5). The status saving code 130 is a code independent of the OS 120. Therefore, in this state, it is impossible to determine where the OS 120 is arranged in a memory with the code. To read a state (code and data) of the OS 120 from the memory space 200, it is necessary to determine which area in the memory space 200 is used. By searching for the page table 202, it is possible to determine an address of the memory space 200.

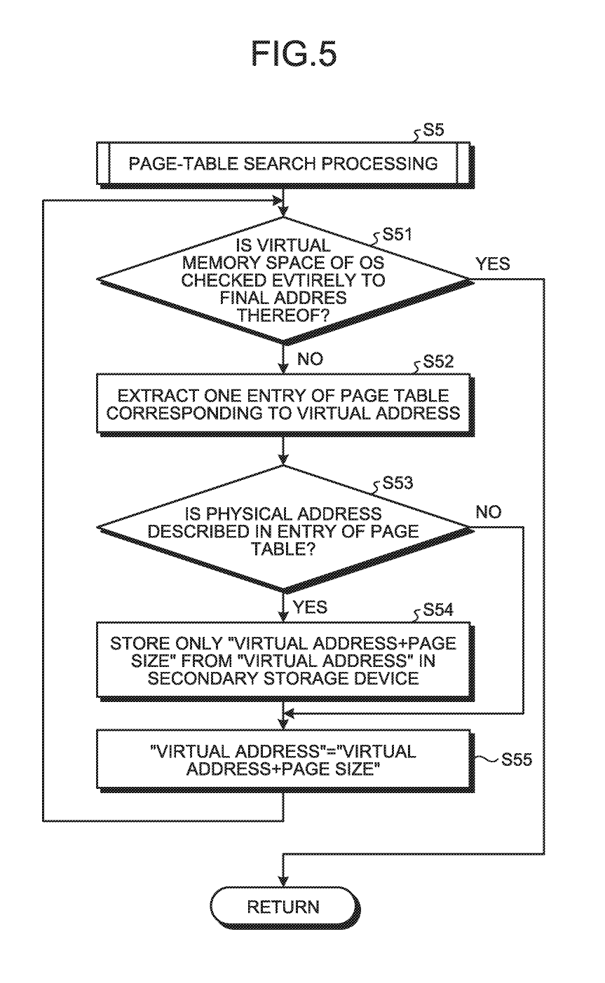

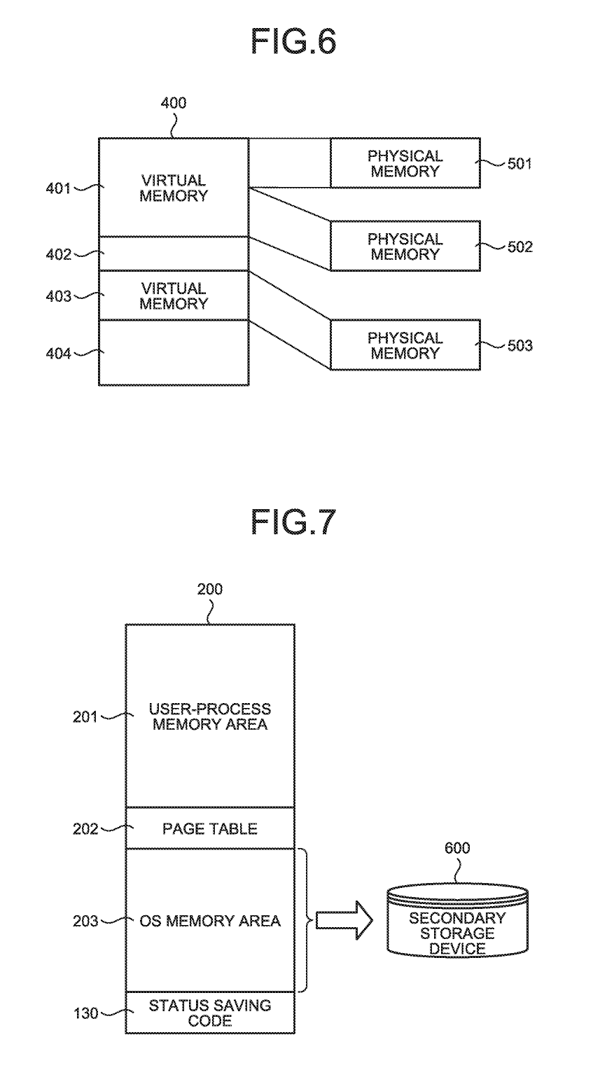

FIG. 5 is a flowchart illustrating a subroutine showing the page-table search processing. FIG. 6 is a diagram illustrating a correspondence relation between a virtual memory space and a physical memory of the OS. As illustrated in FIG. 6, in the virtual memory space 400, virtual memories 401, 403 for having corresponding physical memories 501, 502, and 503, and areas (unused areas 402, 404) having no corresponding physical memory are present.

Firstly, as illustrated in FIG. 5, it is determined whether the virtual memory space 400 of the OS 120 is checked entirely to a final address thereof (step S51).

When it is determined that the virtual memory space 400 of the OS 120 is not checked entirely to the final address thereof (step S51: NO), one entry of the page table 202 corresponding to the virtual address is extracted (step S52).

Furthermore, it is determined whether a physical address is described in the entry of the page table 202 (step S53).

When a physical address is described in the entry of the page table 202 (step S53: YES), contents of the memory space 200 included in “virtual address+page size” is stored in the secondary storage device 600 from “virtual address” (storage step). The page size is an area divided by fixed length for the CPU, and corresponding a virtual address with a physical address is performed in this page unit. The page size is, for example, 4 kilobytes. Moreover, the secondary storage device 600 may be one same as the secondary storage device 300, and may be a storage device other than the storage device 300.

On the other hand, when a physical address is not described in the entry of the page table 202 (step S53: NO), the process proceeds to step S55.

In this state, It is replaced as “virtual address”=“virtual address+page size” (step S55).

Thereafter, returning to step S51, the processing is continued.

At step S51, when it is determined that the virtual memory space 400 of the OS 120 is checked entirely to the final address thereof (step S51: YES), the page-table search processing is ended. That is, until the “virtual address” set to the initial value at step S4 becomes the final address, storing into the secondary storage device 600 is performed, and the entire contents of the virtual memory space 400 is to be stored in the secondary storage device 600.

If the unused areas 402, 404 are accessed to store in the secondary storage device 600, the CPU detects an access to an invalid address, and a failure occurs. In the page-table search processing, contents of the page table 202 is determined, and the contents of the virtual memory space 400 is stored in the secondary storage device 600 while avoiding access to the unused areas 402, 404 and, therefore, a failure does not occur.

FIG. 7 is a diagram illustrating a state in which a log of the OS is output to the secondary storage device. As illustrated in FIG. 7, in the information processing system 1, the contents of the virtual memory space 400, namely, the contents of the OS memory area 203 are stored in the secondary storage device 600 by the page-table search processing. At this time, the status saving code 130 is inhibited to execute the subroutine of the OS 120 and to refer to data of the OS 120. Because it is processing independent of the OS 120, it is not affected by a failure in the OS 120.

Moreover, because the information processing system 1 does not use the virtualization support function of a CPU, the configuration of the embodiment is implementable also in a low-cost PC of not supporting virtualization.

As described above, the information processing system 1 is highly versatile, and is an information processing system that enables to save a status at a time of occurrence of an abnormality without being affected by a failure.

The control program including the status saving code 130 executed in the information processing system 1 according to the present embodiment may be provided, being installed in a ROM or the like in advance.

Furthermore, the control program including the status saving code 130 executed in the information processing system 1 of the present embodiment may be configured to be provided, being recorded in a computer-readable recording medium, such as a compact disk read-only memory (CD-ROM), a flexible disk (FD), a compact disk recordable (CD-R), and a digital versatile disk (DVD), serving as the secondary storage device 300 in a file in an installable format or an executable format.

Moreover, the control program including the status saving code 130 that is executed in the information processing system 1 of the present embodiment may be stored in a computer connected to a network such as the Internet, to be provided by being downloaded through the network. Furthermore, the program that is executed in the apparatus of the present embodiment may be provided or distributed through a network such as the Internet.

According to the present invention, an effect of achieving high versatility, and of being capable of saving a status at a time of occurrence of an abnormality without being affected by a failure is obtained.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An information processing system comprising:
an information processing apparatus that has a status saving code expanded in a specific area being different from an area of an execution format file of an operating system in a memory space of the operating system, when booting or after booting of the operating system, wherein
the information processing apparatus determines a page table of the memory space by proceeding to the specific area to execute the status saving code in case of failure of the operating system, and stores contents of a virtual memory having a corresponding physical memory into a secondary storage device from a virtual memory space of the operating system.

2. The information processing system according to claim 1, wherein
the status saving code includes a command area and a data area.

3. The information processing system according to claim 2, wherein
the command area and the data area are expanded in the specific area by a position-independent code.

4. The information processing system according to claim 2, wherein
the command area and the data area are expanded in the specific area by a linker script.

5. A control method of an information processing system comprising:
expanding a status saving code in a specific area being different from an area of an execution format file of an operating system in a memory space of the operating system, from a secondary storage device, when booting or after booting of the operating system;
proceeding to the specific area in case of failure of the operating system; and
determining a page table of the memory space by executing the status saving code and storing contents of a virtual memory having a corresponding physical memory in a secondary storage device from a virtual memory space of the operating system.

6. A computer-readable recording medium that contain a computer program that causes a computer to execute:
expanding a status saving code from a secondary storage device in a specific area being different from that of an execution format file of an operating system in a memory space of the operating system, when booting or after booting of the operating system;
proceeding to the specific area in case of failure of the operating system; and
determining a page table of the memory space by executing the status saving code and storing contents of a virtual memory having a corresponding physical memory in a secondary storage device from a virtual memory space of the operating system.
